(19) United States
(12) Patent Application Publication
(10) Pub. No.: US 2007/0121150 A1
(43) Pub. Date: May 31, 2007

(54) Document processing apparatus, document processing method and recording medium

(75) Inventors: Tetsuya Kobayashi, Kanagawa (JP); Takao Maekawa, Kanagawa (JP); Makoto Yoshimi, Kanagawa (JP); Kyoko Matsushita, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/528,263

(22) Filed: Sep. 28, 2006

(30) Foreign Application Priority Data
Nov. 25, 2005 (JP) 2005-340705
Nov. 25, 2005 (JP) 2005-340706
Dec. 13, 2005 (JP) 2005-358721

(51) Int. Cl. G06F 3/12

(52) U.S. Cl. 358/1.15; 358/1.13

(57) ABSTRACT

A document processing apparatus performs plural types of processings for a document. The apparatus includes a control unit and a storage unit. The control unit receives an instruction group including a plurality of instructions of performing respective processings for a certain document. The storage unit stores: (i) plural pieces of individual processing result information indicating results of the plurality of processings for the certain document, respectively; and (ii) overall processing result information indicating a result of the overall instruction group.

### BACKGROUND

1. Field of the Invention

The present invention relates to a document processing apparatus such as a composite machine.

2. Description of the Related Art

Recent composite machines include a scanner/printer function and a facsimile (FAX) function as well as an electronic mail (e-mail) communication function while connected to a personal computer via a network. In this way, various types of document processing are not available. A combination of these functions may be used. For example, an instruction may be issued to transmit a document read by a scanner to a telephone number A via facsimile and e-mail it to an e-mail address B.

In the related art processing, the result of each of three types of processings, namely, scanning, facsimile transmission and e-mail transmission has been separately recorded as a log.

To such a composite machine are issued on demand a print request, a facsimile transmission request and other types of requests from a personal computer connected thereto via a network. Process related to a print request by another person may be executed while a series of document processing is under way.

### SUMMARY

According to an aspect of the invention, a document processing apparatus performs plural types of processings for a document. The apparatus includes a control unit and a storage unit. The control unit receives an instruction group including a plurality of instructions of performing respective processings for a certain document. The storage unit stores: (i) plural pieces of individual processing result information indicating results of the plurality of processings for the certain document, respectively; and (ii) overall processing result information indicating a result of the overall instruction group.

### BRIEF DESCRIPTION OF THE DRAWINGS

Exemplary embodiments of the invention will be described in detail with reference to accompanying drawings wherein:

FIG. 1 is a block diagram showing a connection example of a document processing apparatus according to an exemplary embodiment of the invention;

FIG. 2 is a block diagram showing an example of the document processing apparatus according to the exemplary embodiment of the invention;

FIG. 3 is a flowchart showing an example of image processing in the document processing apparatus according to the exemplary embodiment of the invention;

FIG. 4 is an explanatory view showing a storage example of processing result information in the document processing apparatus according to the exemplary embodiment of the invention;

FIG. 5 is a flowchart showing an example of display processing of individual/overall processing result information of the document processing apparatus according to the exemplary embodiment of the invention;

FIG. 6 explains an example of display form of individual processing result information of the document processing apparatus according to the exemplary embodiment of the invention;

FIG. 7 is a flowchart showing an example of display processing of overall processing result information of the document processing apparatus according to the exemplary embodiment of the invention;

FIG. 8 explains an example of display form of overall processing result information of the document processing apparatus according to the exemplary embodiment of the invention;

FIG. 9 explains an example of detailed display form of individual processing result information of the document processing apparatus according to the exemplary embodiment of the invention;

FIG. 10 explains an example of detailed display form of overall processing result information of the document processing apparatus according to the exemplary embodiment of the invention;

FIG. 11 explains another example of detailed display form of overall processing result information of the document processing apparatus according to the exemplary embodiment of the invention;

FIG. 12 explains a display example of a list of related processings of the document processing apparatus according to the exemplary embodiment of the invention;

FIG. 13 explains an example display transition between display screens in the document processing apparatus according to the exemplary embodiment of the invention;

FIG. 14 explains a screen example of an interface presented at the printout of the individual/overall processing result information of the document processing apparatus according to the exemplary embodiment of the invention;

FIG. 15 explains a printout example of the individual/overall processing result information of the document processing apparatus according to the exemplary embodiment of the invention;

FIG. 16 explains another example of storing processing result information of the document processing apparatus according to the exemplary embodiment of the invention;

FIG. 17 explains another example of display form of individual processing result information of the document processing apparatus according to the exemplary embodiment of the invention; and

FIG. 18 explains another example of display form of overall processing result information of the document processing apparatus according to the exemplary embodiment of the invention.

### DETAILED DESCRIPTION

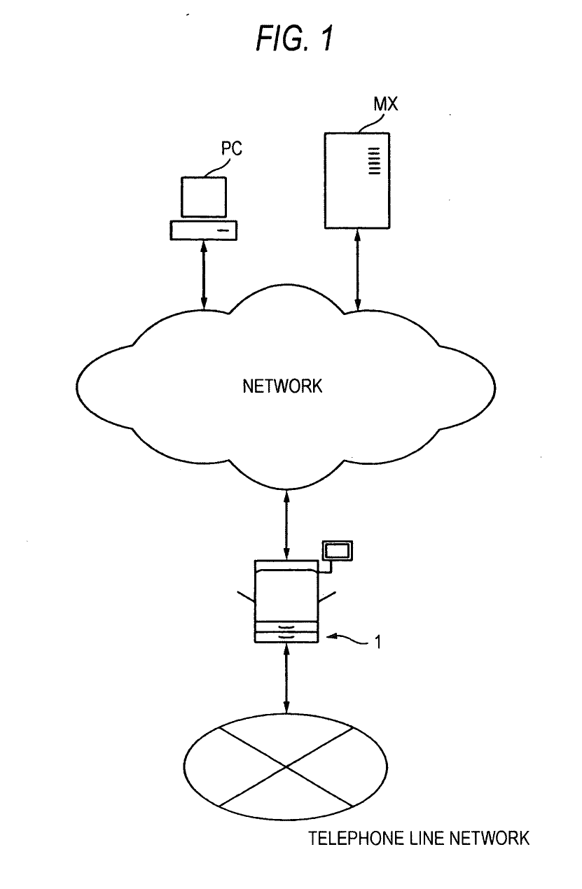

Embodiments of the invention will be described referring to drawings. A document processing apparatus 1 according to an embodiment of the invention is connected to a personal computer (PC) and a mail server (MX) via a network as shown in FIG. 1. The document processing apparatus 1 is also connected to a telephone line network.

The document processing apparatus 1 includes a control section 11, a storage section 12, an image processing section 13, a printer section 14, a scanner section 15, a facsimile function section 16, a communication section 17, an operation section 18 and a display section 19.

The control section 11 may be a CPU and operates in accordance with a program stored in the storage section 12. The control section 11 receives user's instruction operation regarding document processing, input from the operation section 18 and outputs the received instruction to the image processing section 13. Also, when an instruction of displaying log information is input through the operation section 18, the control section 11 reads the log information stored in the storage section 12 and displays the read log information on the display section 19. The processings performed by the control section 11 will be detailed later.

The storage section 12 includes storage devices such as a RAM and a ROM. Also, the storage section 12 may include a storage device such as a hard disk. The storage section 12 stores the program executed by the control section 11 and/or the image processing section 13. The storage section 12 also functions as a work memory for the control section 11 and image processing section 13.

The image processing section 13 controls the printer section 14, the scanner section 15, the facsimile function section 16 and the communication section 17 in accordance with an instruction input from the control section 11 or an instruction received from a PC via a network, reads a document to be processed or prints out or transmits the document to be processed. Upon reading a document with the scanner section 15 or receiving a document from a PC via the communication section 17, the image processing section 13 issues a unique identifier, associates the document acquired through reading or receiving with the unique identifier and stores the acquired document in the storage section 12.

The image processing section 13 accumulates in the storage section 12 information of a processing result of each processing for a document and information of a result in terms of an overall processing, as log information in association with the identifier of the document to be processed. The processings by the image processing section 13 will be detailed later.

The printer section 14 prints out a document image in accordance with an instruction input from the image processing section 13. The scanner section 15 optically reads an image of a printed matter placed on its reading surface and outputs the read image as document data to the image processing section 13.

The facsimile function section 16 may be a facsimile transmission/reception unit. The facsimile function section 16 dials a specified telephone number in accordance with an instruction input from the image processing section 13 and transmits via facsimile an image of a document specified by the image processing section 13 as a processing target.

The communication section 17 may be a network card connected to a network, and is connected to the network. The communication section 17 receives an instruction transmitted from a PC and outputs the received instruction to the image processing section 13. Also, the communication section 17 sets a specified electronic-mail address as a destination in accordance with an instruction input from the image processing section 13, and transmits via an e-mail to a mail server (MX) data of a document to be processed.

The operation section 18 may be a keypad or a touch panel overlaid on the display section 19. The operation section 18 accepts user's instruction operation and outputs information indicating content of the instruction operation to the control section 11. The display section 19 may be a liquid crystal display and displays information in accordance with an instruction input from the control section 11.

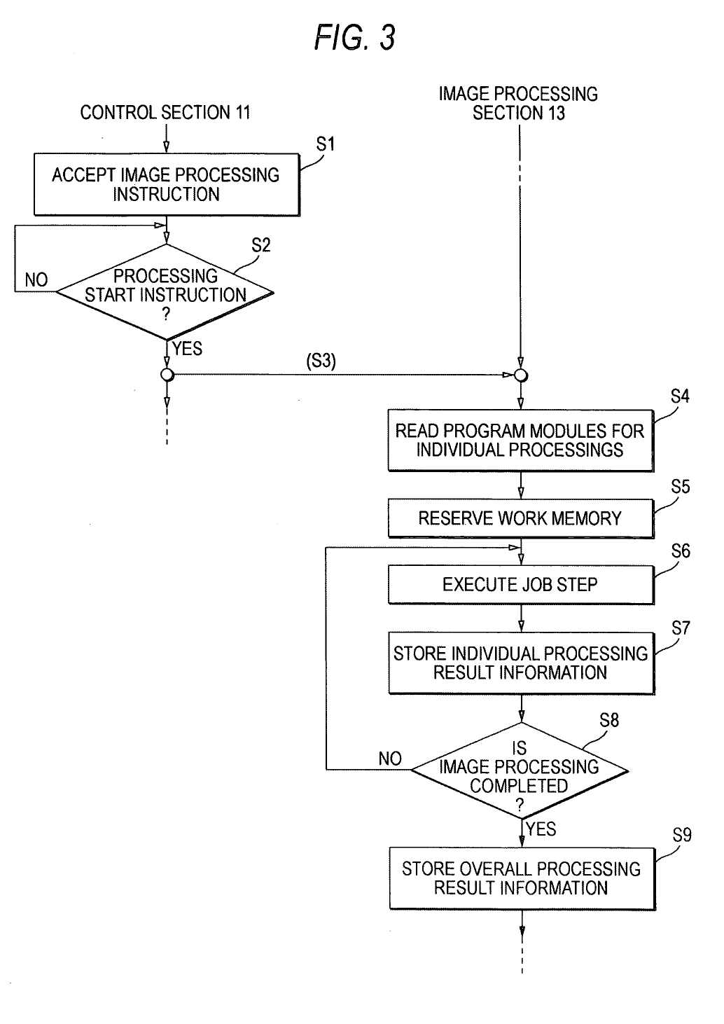

Operation of the control section 11 and that of the image processing section 13 will be described referring to FIG. 3. When contents of a series of image processings to be executed are specified by the instruction operation performed through the operation section 18, the control section 11 stores information describing an instruction of the series of image processings into the storage section 12 (S1). For example, the instruction of the image processings is a broadcasting instruction describing a plurality of telephone numbers and a plurality of facsimile transmission instructions.

The control section 11 waits until a processing start instruction is issued (S2). When the processing start instruction is issued, the control section 11 requests the image processing section 13 to perform the instruction of the image processings stored in the storage section 12 (S3). In response to this request, the image processing section 13 executes the instruction of the image processings. In this embodiment, the image processing section 13 reads out from the storage section 12 program modules, which correspond to individual processings such as a processing of outputting an image of a document to the printer section 14 to cause the printer section 14 to print out the image of the document, a processing of controlling the scanner section 15 to read an image of a document, and a processing of controlling the facsimile function section 16 to transmit via facsimile an image of a document (S4). The image processing section 13 reserves a work memory used to execute a user's processing (job) on the storage section 12 (S5). The image processing section 13 executes one of the processings (job step) included in the instruction (S6). In this example, the job step is a facsimile transmission to each destination.

Each program module executed by the image processing section 13 includes an instruction of storing into the storage section 12 a result of a corresponding executed processing as individual processing result information while associating the individual processing result information with the identifier of a document to be processed. Thus, the image processing section 13 stores the individual processing result information into the storage section 12 each time, for example, a processing of a facsimile transmission to one destination is performed (each time a processing of a job step is completed) (S7).

The individual processing result information includes the identifier of a document to be processed, type information to specify a processing type, processing parameter information, code information indicating a processing result (result such as transmission complete, destination busy, and transmission error), and information indicating date/time of the processing.

The type information is for example character string information related to the executed processing such as “facsimile transmission” and “print process.” The process parameter information may be parameter information, which is related to content of a processing and previously set for each processing type. In the case of the fax transmission, examples of the processing parameter information include a destination telephone number and name of destination. In the case of copying, examples of the processing parameter information include selected paper size and scaling factor. In the case of scanning, examples of the processing parameter information include reading resolution and stored document type (file format such as PDF and JPEG) of a read document. The result code may be numerical information indicating each result or character string information. Information indicating the date/time of processing is data/time acquired at the beginning and end of the processing from an IC chip (not shown) to provide a calendar/clock function (hereinafter referred to as a clock section).

When judging that the image processing requested by the control section 11 is completed (S8), the image processing section 13 references to the individual processing result information stored in the storage section 12 to generates overall processing result information indicating an overall result of the series of image processings and stores the generated overall processing result information into the storage section 12 (S9) to complete the series of processings.

The overall processing result information includes the identifier of the document to be processed, summary information and information of the date/time at time points of processing start and processing end. For example, when all the individual processing result information, which have been stored in the storage section 12 with being associated with the identifier of the document to be processed, indicate successful completion, the summary information is set as successful completion information indicating “successful completion.” When any of the individual processing result information indicates that an error has occurred, the summary information is set as abnormal termination information indicating that a certain process resulted in an error.

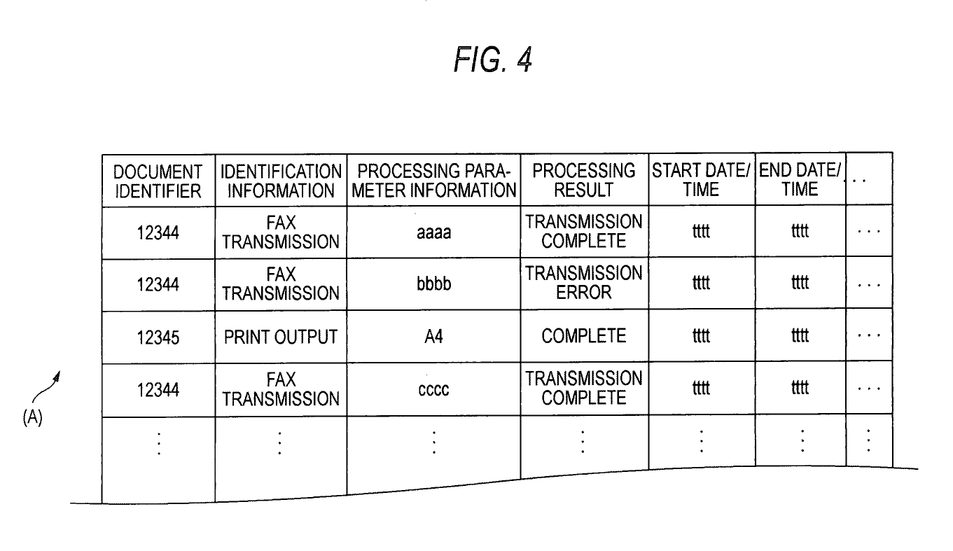

In this embodiment, the image processing section 13 executes a plurality of processings in parallel (multitasking) If the recorded individual processing result information and the recorded overall processing result information are arranged in time series of recording, the individual processing result information of facsimile transmissions included in broadcasting are not necessarily consecutive and other individual processing result information relating to printing processing performed between the broadcasting processings may be arranged between the broadcast processings (see FIG. 4A).

The image processing section 13 may count the individual processing result information, which are stored in the storage section 12 with being associated with the identifier of the document to be processed, generate information indicating a occurrence ratio of at least some of the result codes and make the summary information of the overall processing result information include the information on the occurrence ratio.

For example, the image processing section 13 counts as a total number, number of individual processing result information, which are stored in the storage section 12 with being associated with the identifier of the document to be processed. Also, the image processing section 13 counts as a sum value, number of results codes indicating successful completion of the processings among the individual processing result information, which are stored in the storage section 12 with being associated with the identifier of the document to be processed. The sum value is divided by the total number to obtain a ratio and the obtained ratio is stored into the storage section 12 as an occurrence ratio of successful completion together with the overall processing result information.

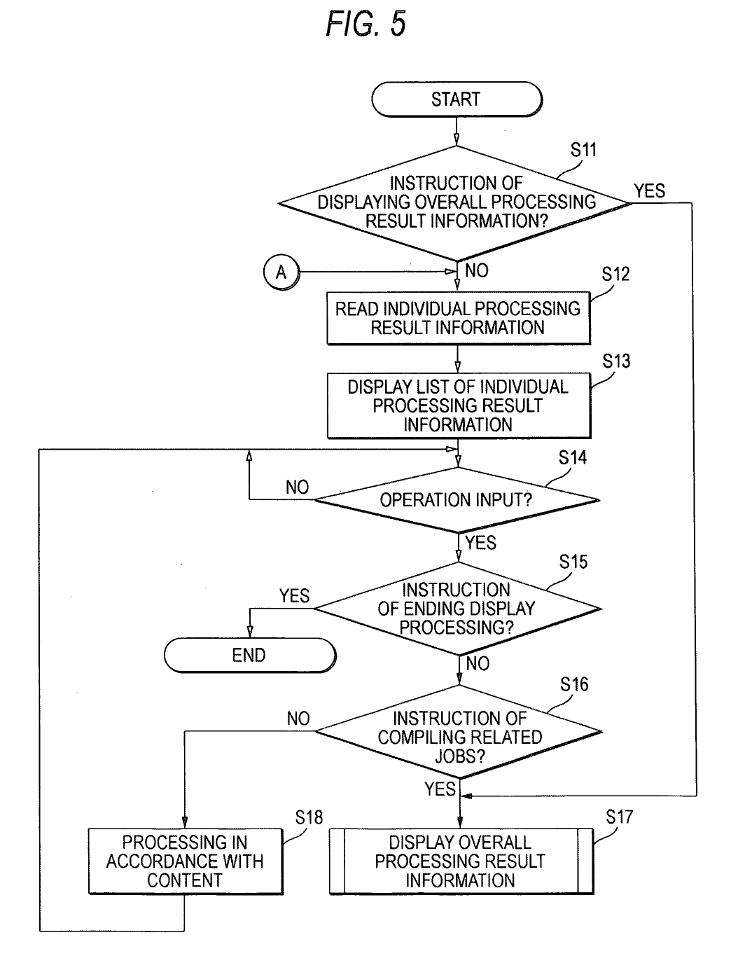

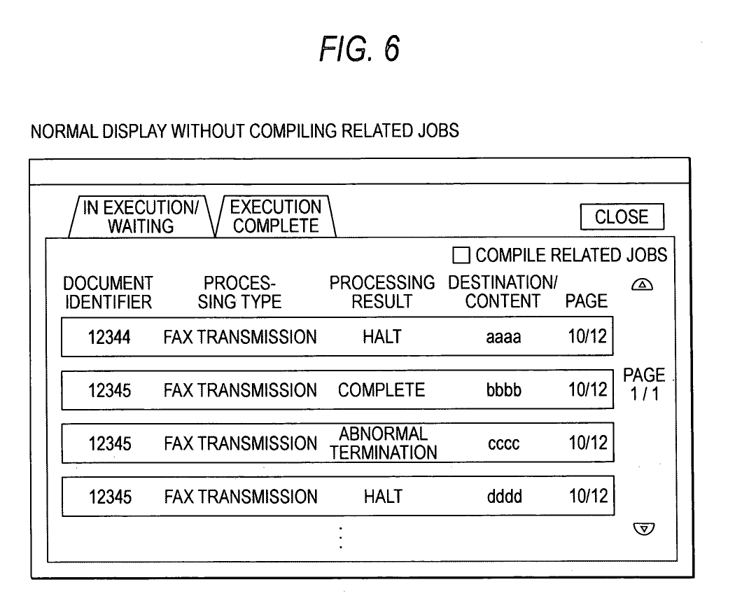

Next, an output processing of the individual processing result information and the overall processing result information thus recorded will be described. For example, upon receiving a request to display information of each processing result from the operation section 18, the control section 11 start processing shown in FIG. 5. The control section 11 checks whether or not an instruction of displaying the overall processing result information is given by the accepted request or a predetermined setting (S11). If the instruction of displaying overall processing result information is not given at step S11 (No), the control section 11 reads the individual processing result information stored in the storage section 12 (S12). Then, the control section 11 displays a list of the individual processing result information on the display section 19 (S13). Here, contents of the display output may include, as shown in FIG. 6, individual processing result information arranged in reverse time series of occurrence. The list of the individual processing result information may be divided and displayed on plural pages in consideration of the size of the display area of the display section 19.

A user can issue an instruction of displaying the overall processing result information by tapping a “Compile related jobs” check box (unmarked in FIG. 6). That is, when an operation is made through the operation section 18, the control section 11 checks whether or not the operation is an instruction of terminating the display (S15). If it is an instruction of terminating the display, the control section 11 terminates the display of the individual processing result information. If the operation at step S15 is not an instruction of terminating the display, the control section 11 checks whether or not the instruction pertains to “Compile related jobs” (tapping in the check box) (S16). If such an instruction is given, the control section 11 starts displaying the overall processing result information stored in the storage section 12 (S17). This processing will be described later.

Further, if the instruction does not pertain to “Compile related jobs” at step S16, the control section 11 executes a processing in accordance with content of the instruction (S18) and returns to step S14 for further processing. If an instruction of displaying the overall processing result information is given at step S11, the control section 11 proceeds to step S17 to start displaying the overall processing result information.

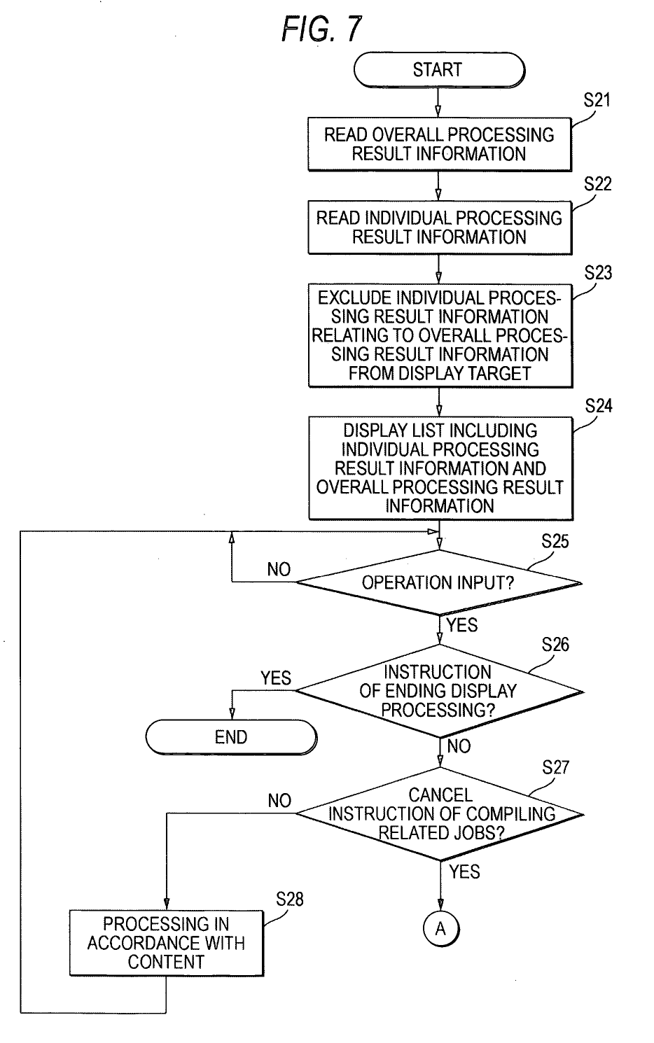

Next, the display of the overall processing result information at step S17 will be described referring to FIG. 7. The control section 11 first reads the overall processing result information from the storage section 12 (S21). The control section 11 then reads the individual processing result information from the storage section 12 and stores the read individual processing result information in the work memory (S22). The control section 11 references to the identifier of a document included in the individual processing result information read at step S22 to delete from the work memory the individual processing result information including the same document identifier as that included in the overall processing result information read at step S21 in order to exclude such individual processing result information from the display content (S23).

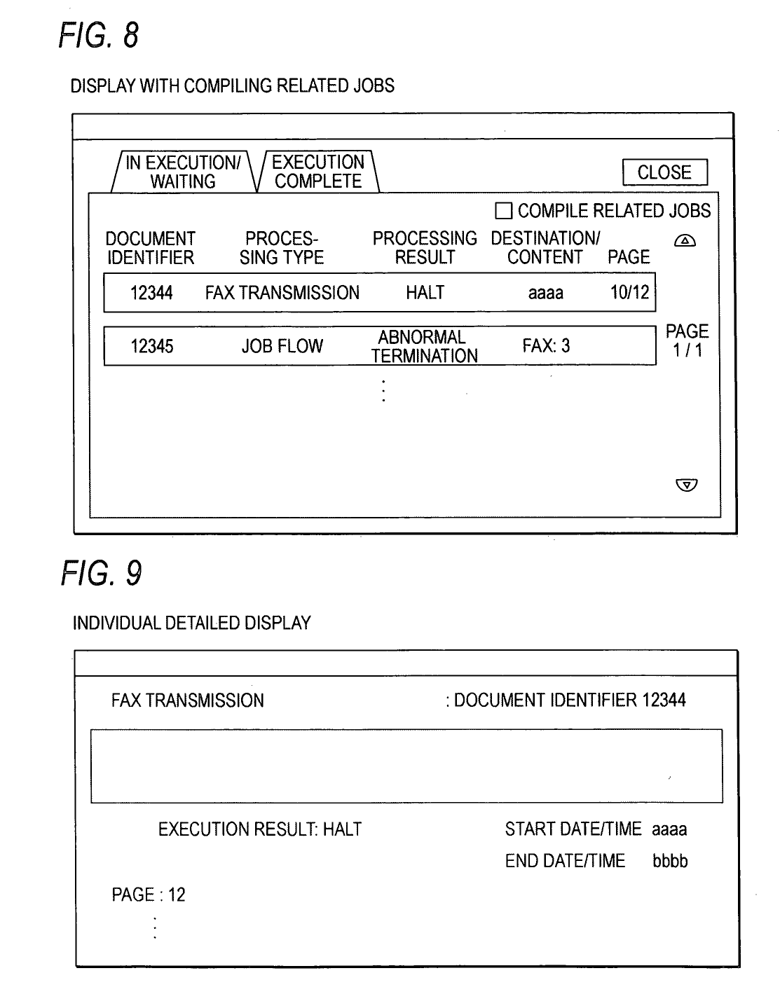

The control section 11 rearranges the overall processing result information read at step S21 and the individual processing result information remaining in the work memory in accordance with the date/time information included in both of the overall processing result information and the individual processing result information. Then, the control section 11 displays on the display section 19 a list of the rearranged information in reverse time series of the date/time information (S24). The list of the rearranged information may be divided and displayed on plural pages in consideration of the size of the display area of the display section 19. An example of the list of the rearranged information is shown in FIG. 8. While the information is arranged in reverse time series of the date/time information in this example, the information may be arranged in time series of the date/time information (starting with the earliest date/time). The information may be given in an order different from the time series of the date/time information. The display order may be determined by the user.

The display of the overall processing result information also includes the “Compile related jobs” check box (marked in FIG. 8). Display of the overall processing result information may be made inactive by tapping the check box. That is, when an operation is made through the operation section 18, the control section 11 checks whether or not the operation is an instruction of terminating the display (S26). If it is an instruction of terminating the display, the control section 11 terminates the display of the individual processing result information. If the operation at step S26 is not the instruction of terminating the display, the control section 11 checks whether or not the instruction pertains to cancellation of “Compile related jobs” (tapping in the check box) (S27). If an instruction is given, the control section 11 proceeds to step S12 shown in FIG. 5 for further processing. If the instruction does not pertain to cancellation of “Compile related jobs” at step S27, the control section 11 executes a processing in accordance with content of the instruction (S28) and returns to step S25 for further processing.

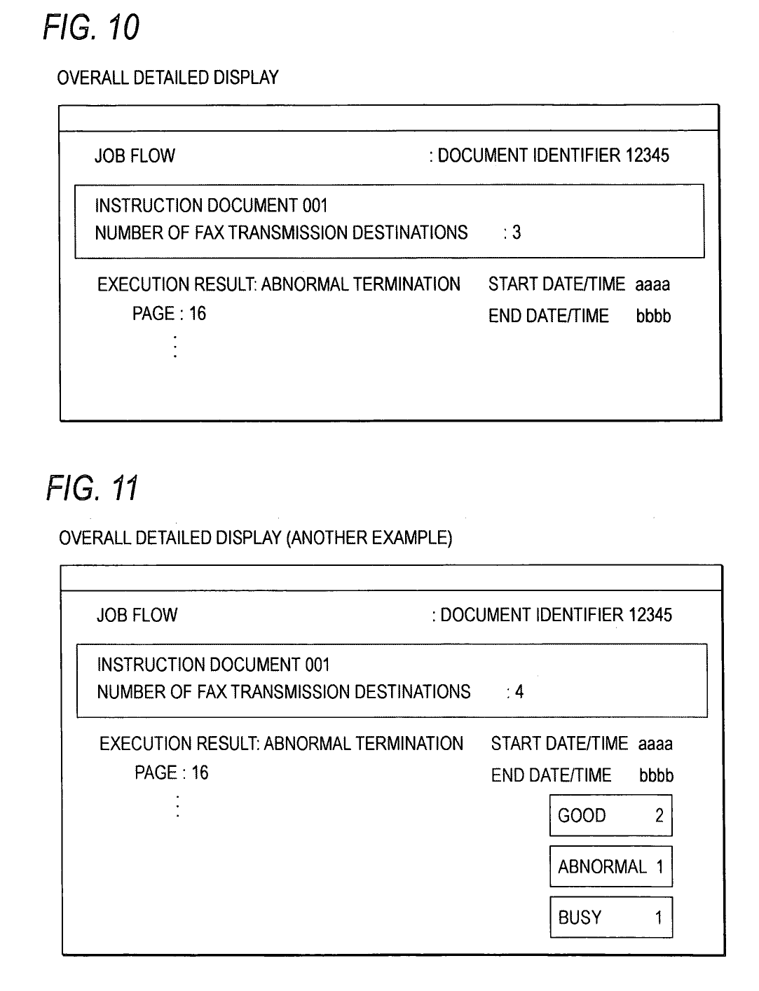

In this embodiment, the “Compile related jobs” check box functions as a forward-reverse button to select either the overall processing result information is displayed or not. If any of the individual processing result information is selected (tapped) on the screen displaying the individual processing result information shown in FIG. 6, the control section 11 gives a detailed display of various kinds of information included in the selected individual processing result information at step S18 (FIG. 9). Similarly, if any of the individual processing result information is selected on the screen shown in FIG. 8, the control section 11 performs a detailed display at step S28, in a similar manner to FIG. 9. If any of the overall processing result information is selected on the screen shown in FIG. 8, the control section 11 performs detailed display of the selected overall processing result information (overall detailed display) at step S28 (FIG. 10). The screen shown in FIG. 10 includes information for specifying the description of an instruction input from the control section 11 (“instruction document 001”). The processing type is displayed as a “job flow”.

If the overall processing result information in the display or detailed display at step S24 includes ratio information indicating the ratio of the successful completion, the ratio of the abnormal termination or the ratio of a specific result code, the ratio information may be displayed.

Although described is the case where different result codes are assigned to respective causes of transmission failure (abnormal termination of process), the result codes may only include successful completion (no error occurs) and abnormal termination (an error occurs). In this case, the overall processing result information may include a ratio of the result code corresponding to at least one of the successful completion and the abnormal termination.

In the case where there are a plurality of result codes indicating situations to be determined that an error occurs and a plurality of result codes indicating situations to be determined that no error occurs—such as a case where different result codes are assigned to respective causes of the abnormal terminations—, it may be set for each result code whether or not the result code is to be determined that an error occurs. For example, in the case where result codes fall within a range of −127 to 128 and the situations of processing result relating to respective causes are assigned to the values in this range, the negative values may correspond to errors and the positive values may correspond to no error.

Further, when a user inputs a result code in the display screen shown in FIG. 6 or FIG. 8, the control section 11 may perform processing of selectively displaying individual processing result information including the input result code input.

If the ratio information is tallied for each result code, the control section 11 may provide the ratio information for each result code (occurrence ration itself or number of occurrences) in the detailed display (overall detailed display: FIG. 10) in the case where single overall processing result information is selected or in the list display. For example, FIG. 11 shows an example of displaying the ratio information in the overall detailed display. In this case, when any of the result codes is selected, the control section 11 may acquire a document identifier included in the overall processing result information currently displayed, search the storage section 12 for individual processing result information including the acquired document identifier and the selected result code and then display a list of the search result. Thereby, of the individual processing result information relating to the overall processing result information currently displayed, the control section 11 can selectively display processings, which have resulted in a processing result indicated by a specific result code. The list may be displayed on the screen shown in FIG. 10 or FIG. 11.

Described so far is the case where switching between display of individual processing result information and display of overall processing result information is performed with the check box “Compile related jobs.” Alternatively, while individual processing result information is being displayed, the control section 11 may accept an instruction of displaying overall processing result information relating to specific individual processing result information (for example, selected individual processing result information or individual processing result information details of which are currently displayed), refer to document identifier included in the specific individual processing result information, search the storage section 12 for overall processing result information including the document identifier referred to and display the search result.

Since the individual processing result information includes a processing type, the control section 11 may accept an instruction of displaying individual processing result information of a specific processing type, selectively acquire the individual processing result information including information of the specific processing type relating to the instruction from the storage section 12 and display the list of the searched result. In this case, the control section 11 may display on the display section 19 a list of processing types that could be included, and allow a user to select a processing type to be displayed.

In this case, while individual processing result information service types of which are specified are being selectively displayed, the control section 11 may accept an instruction of displaying overall processing result information relating to specific individual processing result information (for example, selected individual processing result information or individual processing result information details of which are currently displayed), refer to document identifier included in the specific individual processing result information, search the storage section 12 for overall processing result information including the document identifier referred to and display the search result.

While individual processing result information service types of which are specified are being selectively displayed, the control section 11 may further accept an instruction of specifying at least one of individual processing result information selectively displayed and displaying another individual processing result information relating to the specified individual processing result information, refer to document identifier included in the specified individual processing result information, search the storage section 12 for individual processing result information including the document identifier referred to and display the search result. Thereby, irrespective of the specified processing type, the related individual processing result information are provided.

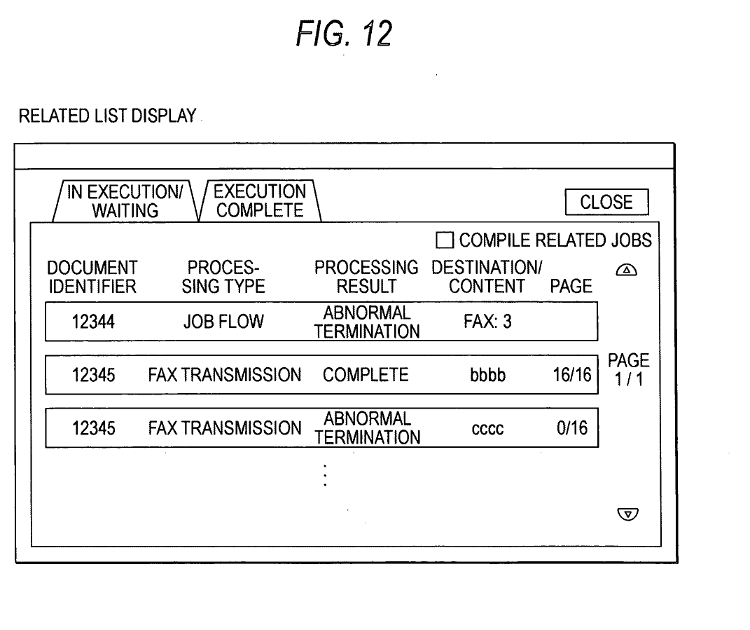

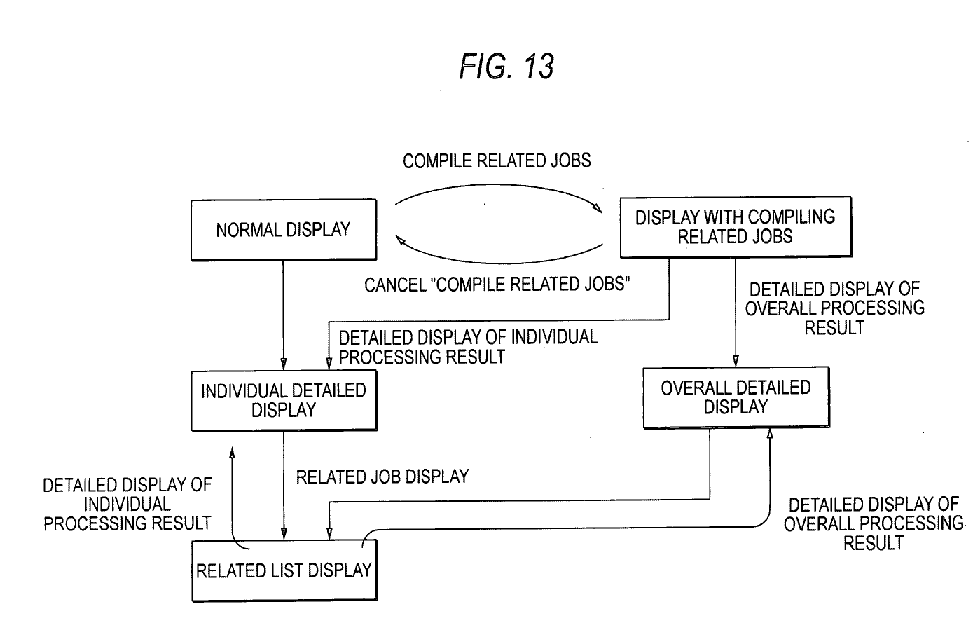

When a user issues an instruction of “displaying related individual processing result” on the display screen of the overall detailed display (display screen exemplified in FIGS. 10 and 11), the control section 11 may further refer to document identifier included in the individual processing result information currently displayed, search the storage section 12 for individual processing result information including such a document identifier and display a list of the overall processing result information and the individual processing result information (related list display: FIG. 12). Also, when a column of the overall processing result information is selected on the related list display screen to issue an instruction of detailed display, the control section 11 proceeds to the overall detailed display screen shown in FIG. 10 or 11. Also, when a column of the individual processing result information is selected to issue an instruction of detailed display, the individual detailed display is performed as shown in FIG. 9. Also, the overall processing result information may not be displayed on the display screen shown in FIG. 12. Although FIG. 12 shows the example where jobs in execution/waiting and completed jobs are switched with the tab and displayed, a list of jobs in execution/waiting and a list of completed jobs may be displayed side by side on the same page. Thereby, even if the display is not switched with the tab, individual processing result information included in the overall processing result information can be confirmed more clearly. Furthermore, when an instruction of “displaying related individual processing results” is received while the individual detailed display screen as shown in FIG. 9 are being displayed, similarly the control section 11 may refer to document identifier included in the individual processing result information currently displayed, search the storage section 12 for individual processing result information (may search for overall processing result information together) including the document identifier referred to and display a list of the search result as shown in FIG. 12. As described above, in this embodiment, respective displays can be switched therebetween by way of instructions as shown in FIG. 13.

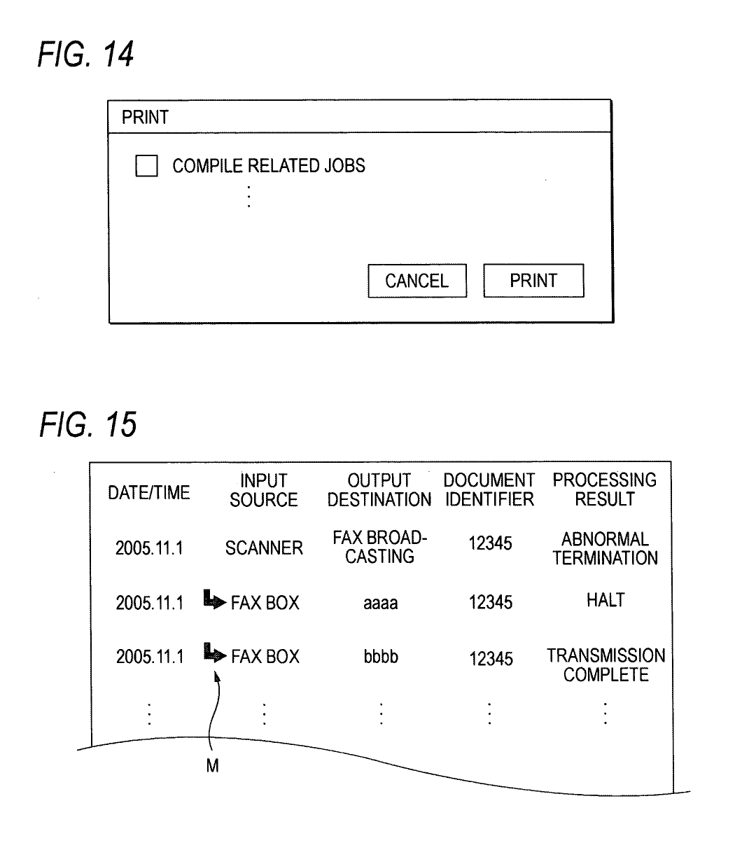

The control section 11 may further receive an instruction of printing displayed content and instruct the printer section 14 to print out the individual processing result information or overall processing result information, which is listed or displayed in detail. For example, upon receiving the instruction of printing individual processing result information or overall processing result information (FIG. 14), the control section 11 may display a screen for inquiring whether or not to “compile related jobs. When “Compile related jobs” is selected, the control section 11 may execute the same processing as display of overall processing result information, generate the same screen as that shown in FIG. 8 and cause the printer section 14 to perform printing processing.

In this case, the control section 11 may print out plural pieces of individual processing result information included in each overall processing result information with the plural pieces of the individual processing result information arranged successively in units of the overall processing result information. That is, the control section 11 may rearrange the individual processing result information in accordance with document identifiers and instruct to print a list of the rearranged result.

Furthermore, when overall processing result information and the related individual processing result information (relating to the same document identifier) are printed, the overall processing result information may printed at the head and the individual processing result information may be printed together with a mark (such as a symbol or character string: e.g., “M” shown in FIG. 15). This print order or display of the mark may be canceled in accordance with an instruction or prior setting.

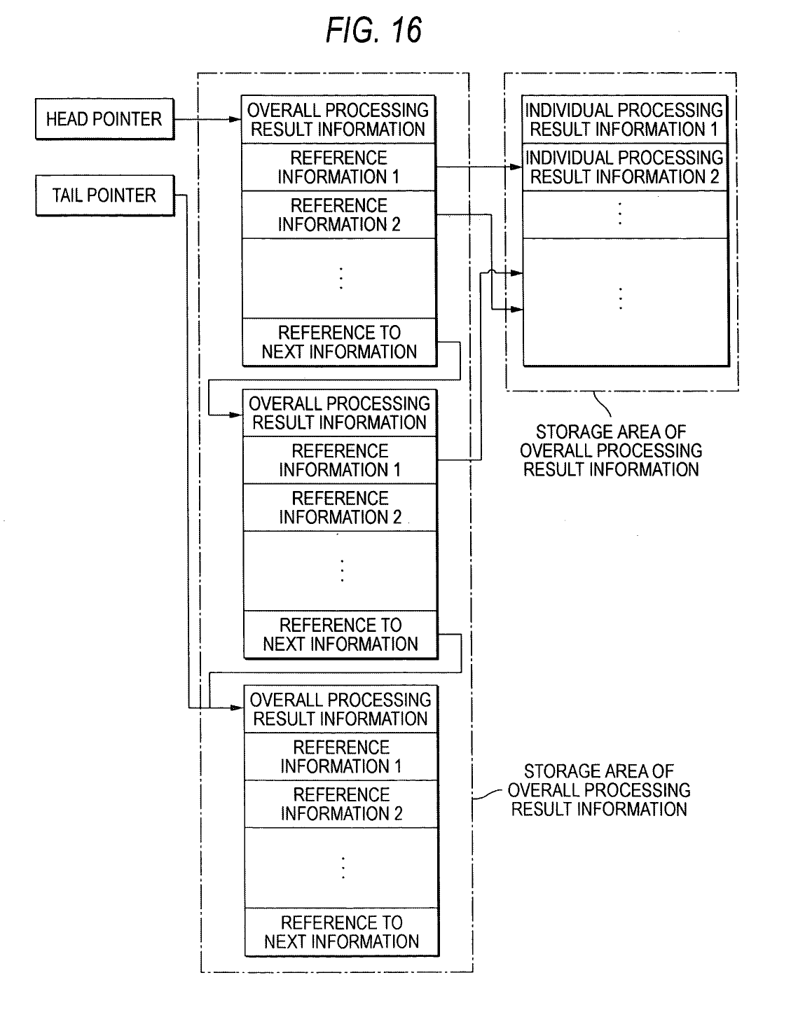

Furthermore, although overall processing result information and individual processing result information are associated with each other by a document identifier in the foregoing description, the invention is not limited thereto. For example, when the image processing section 13 reserves the recording area of overall processing result information in the storage section 12 at the beginning of a processing; stores individual processing result information at each job step during the processing into the storage section 12, the image processing section 13 may sequentially record reference information, which indicates a storage area where the recorded individual processing result information is stored, in the storage area of the overall processing result information; and generate the overall processing result information at the end of the processing as well as generate information (result information set) including the overall processing result information and reference information with respect to the related individual processing result information. In this case, each result information set may include reference information indicating a storage area of the next result information set to be recorded (FIG. 16).

The image processing section 13 may store in the storage section 12 a head pointer indicating the storage location of the result information set, which has been recorded earliest in chronological order, and a tail pointer indicating the storage location of the result information set, which has been recorded latest in chronological order, among the result information sets stored in the storage section 12.

Described above is the case where the control section 11 accepts an instruction of displaying individual processing result information or overall processing result information and outputs the target information to the display section 19. Alternatively, the control section 11 may receive individual processing result information or overall processing result information from a PC via a network; execute the same display processing; generate and provide a list or detailed display of the target information as an HTML document to the requesting PC; and display the information on the PC screen for the user, instead of displaying on the display section 19.

Each execution step of the job flow in the above description may be treated as an individual processing and the whole jog f low may be treated as an overall processing to record and provide the processing result. In this case, the job flow may include different type processings from each other.

Here, the job flow defines a function of executing a plurality of registered tasks as a series of tasks. The user prepares an instruction document describing an execution order and processing conditions for a series of processings, and registers the instruction document in the storage section of the document processing apparatus or in a storage means connected to the document processing apparatus through a network. Examples of the series of processings include a typical series of processing, which would be performed repeatedly many times, and a series of processings, which are common in a certain company or a certain department. That is, the job flow is a kind of program and a plurality of processing instructions are defined with execution order. The processing instructions of a job flow may be processed in the specified order or sequentially executed in accordance with a prespecified rule by way of a so-called branch processing that is based on a predetermined processing condition.

A series of flows including a plurality of processing types from a document generation through document processings to a document output are described in the instruction document together with its processing order and conditions. The plural types of processings may include a method for acquiring a document to be processed in the job flow (such as acquiring a document by scanning, acquiring a document from a folder, acquiring a document from a box provided in the document processing apparatus, acquiring a document by polling receiving); a method for processing a document (such as content of an image processing, conditions of the image processing, presence/absence of character recognition processing, processing of recognized character information and changing document format); and a method for outputting a document (storing a document in a folder, transmitting a document as a mail, coordinating with an application software inside/outside the document processing apparatus, printing out a document and faxing a document).

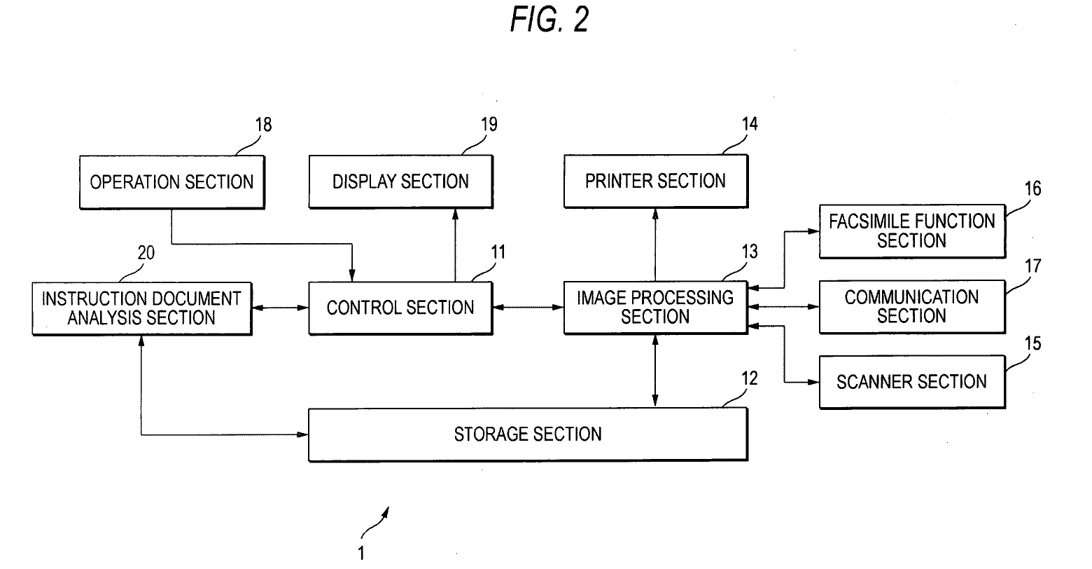

An example of configuration of a document processing apparatus in the case where a job flow is processed will be described below with reference to FIG. 2. The user prepares an instruction document describing the flow of a series of processings as well as related processing order and conditions, by using a personal computer (PC) connected to the document processing apparatus via a network. Then, the user registers the prepared instruction document in the storage section 12.

When the user instructs to start the job flow through the operation section 18, the control section 11 displays on the display section 19 a list of instruction documents registered in the storage section 12 in response to this operation made through the operation section 18.

The user operates the operation section 18 to select an instruction document defined for a desired processing from among the plurality of instruction documents displayed on the display section 19. In specifying an instruction document, if necessary, the control section 11 may display on the display section 19 the flow or conditions for a processing registered in a specific instruction document from among the listed instruction documents so that the user can check the registration.

An instruction document analysis section 20 interprets the instruction document, which is described based on a certain rule, to develop the processing order and processing conditions for individual processings constituting the series of processings registered in the instruction document. The instruction document analysis section 20 outputs contents of an instruction to the control section 11, the image processing section 13, the scanner section 15, the printer section 14, the facsimile function section 16 and the communication section 17. These sections execute the series of processings based on the described processing order of the individual processings and under the described processing conditions.

An example where a method for capturing a document is described as one of the series of processings described in the instruction document will be described. If an individual processing of acquiring a document with the scanner section 15 is described, processing conditions such as scan condition are determined in accordance with the description of the instruction document to optically read an image of a printed matter with the scanner section 15. If an individual processing of acquiring a document from a folder is described, a file destination described in the instruction document (for example, a server on a network or a predetermined folder in a computer) is accessed to via the communication section 17 to acquire a file, and the acquired file is temporarily stored in the storage section 12.

An example of the method for outputting document will be described. If an individual processing regarding an output method via printout is described, printout conditions are determined in accordance with the description of the instruction document to print out a document with a printer section 14. If a mail transmission processing is described as an individual processing, an e-mail transmission is made to a mail server connected via the communication section 17 while an e-mail address described in the instruction document is set as a destination. If a facsimile transmission is described as an individual processing, a destination telephone number described in the instruction document is dialed using the facsimile function section 16 to transmit a document image via facsimile.

By executing a job flow defined by the instruction document, it is possible to execute a plurality of functions (such as scan, facsimile transmission, file transfer, printout, copy and image processing) as a series of document processings in accordance with the processing conditions and processing order described in the instruction document.

In the job flow processing, the relation between overall processing and individual processings according to the invention is established. A result of a series of jobs referred to as a job flow, which is described in the instruction document specified by the user, corresponds to an overall processing result. Results of individual processings in a series of jobs registered as a job flow correspond to an individual processing results. Thus, these jobs may be processed as a target of display processing in a similar manner to the facsimile transmission described above.

That is, if each step of processing considered as an individual processing and the whole processing is considered as an overall processing, it is possible to generate individual processing result information and overall processing result information described above and provide those information to the user for use by the user.

Display switch between an overall processing result of a job flow and individual processing results of the job flow will be described using an example.

In this example, display of a processing result will be described in the case where a job flow includes scanning five documents; transferring and storing the scanned documents in electronic form in a personal computer (PC) connected via a network; transmitting the documents as e-mails to two destinations; and printing out the scanned documents.

The job flow is composed of five individual processings of different types: (1) Scanning documents; (2) Transferring the scanned documents to a PC; (3) Transmitting the documents to a first destination via an e-mail; (4) Transmitting the documents to a second destination via an e-mail; and (5) Printing the scanned documents. It is assumed that in this job flow having the five individual processings, the documents are successfully scanned, transferring to/save into the PC has failed, then e-mail transmission to two destinations is successfully completed, and printout is successfully completed.

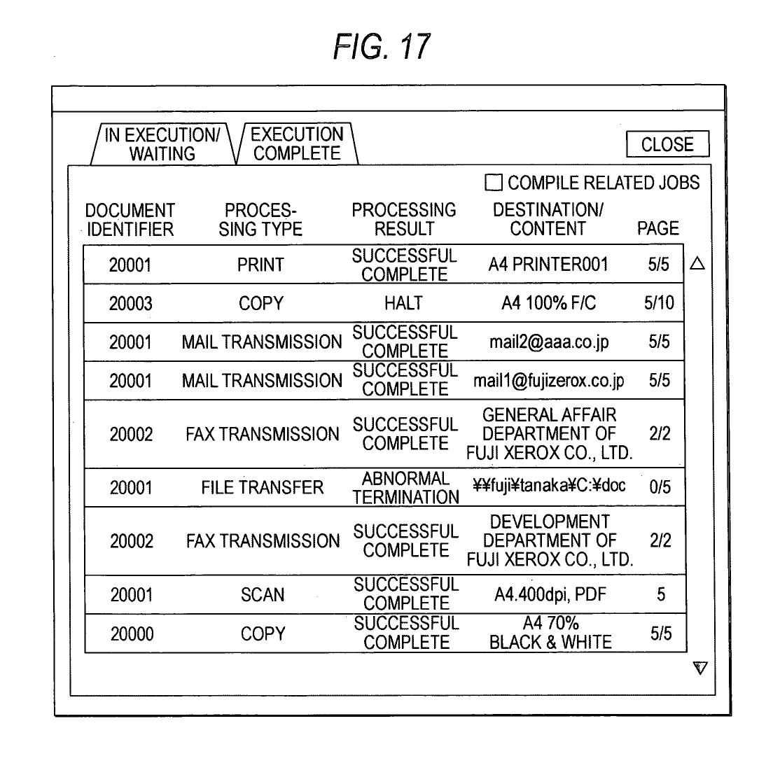

In the case where results of individual processings are displayed in a conventional manner, the individual processing results are displayed in chronological order in which the processings are completed. The processing result display at that time is shown in FIG. 17. In FIG. 17, a common document identifier 20001 is assigned to the job flow having the five individual processings.

FIG. 17 shows an example where the latest individual processing result is displayed in the uppermost position and an individual processing result is displayed in a lower position as longer time has elapsed since the individual processing was completed. That is, in the display form shown in FIG. 17, a processing of printing five A4 sheets with the printer 001 is the most recently completed job. It is matter of course that if the processing results are numerous and exceed one page, the display may be scrolled through or processing results may be provided on plural pages and switching between pages may be made by a page switching instruction in order to display all processing results.

Also, setting may be made so as not to display processing results, a predetermined time has elapsed since which was completed.

At that time, it is preferable to make display control so that for an individual processing constituting an overall processing, other individual processings relating to the subject individual processing are displayed until a predetermined period has elapsed since the last individual processing was completed among all individual processings, even when the predetermined time period has elapsed since the other individual processings were completed. Such display control is preferable that if a predetermined period has elapsed since the last individual processing was completed, results of the individual processing and the related other individual processings are not displayed.

By performing this display control, it is possible to avoid a situation where when individual processing results are displayed, even though a part of the individual processing results the predetermined time period has not elapsed since which were completed among the individual processing constituting the overall processing, another part of the individual processing results are not display the predetermined time period has elapsed since which were completed. This prevents a user from being confused due to the fact that a part of the overall process result is not displayed.

It is assumed that, in the individual processing results shown in FIG. 17, after the scanned documents are transmitted as e-mails to the two destinations during the series of processings by the job flow, a copy job, which does not relate to the job flow, is executed. In such a case, since the individual processing result display shown in FIG. 17 lists individual processing results in chronological order or in the order processings are executed, an individual processing of copy job, which does not relate to the job flow, having a document identifier 20001 is displayed between the e-mail processing result and the print processing result, which are the individual processing results by the job flow of the document information 20001.

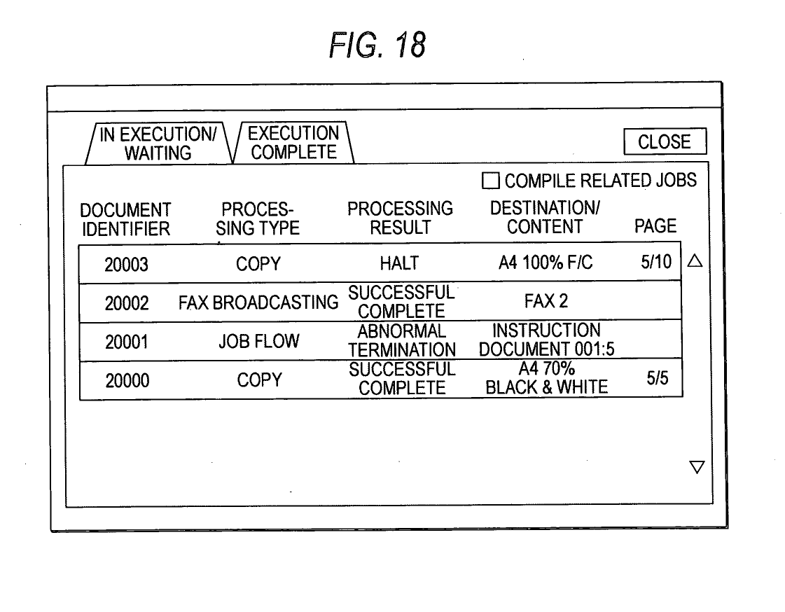

FIG. 18 shows an exemplary display of the overall processing results assumed in case the jobs related to the individual processing results shown in FIG. 17 are compiled. Switching of display form from the individual processing result display to the related overall processing result display uses the same operation as in the case of a broadcasting instruction.

In case a plurality of job flows are under simultaneous execution, a plurality of job flows may appear in the overall processing results. Thus, the job flow column displays information to identify executed job flows in order to enhance ease of use. In this example, the name of an instruction document describing the series of processings of a job flow and information on how many individual processings constitutes the job flow are used to identify the job flow. Further, the document name of a scan document, the mail topic name related to a job flow including an e-mail transmission job, a character string extracted based on the result of text recognition of a scan document, or information on the destination of instruction document assumed in case the instruction document is transmitted from an external terminal may be displayed to help the user identify the job flows executed by the user, thereby allowing the user to recognize the job flows executed by the user with more ease.

FIG. 18 displays the processing results depending on whether the job flow of the document identifier 20001 has all of the series of processings as a job flow normally completed or some of them abnormally completed. According to the example of this embodiment, the individual processing of file transfer has been abnormally complete so that all of the series of processings of the overall processing are not normally complete. As a result, the job flow of the document identifier 20001 is abnormally complete.

What is claimed is:

1. A document processing apparatus for performing plural types of processings for a document, the apparatus comprising:
a control unit that receives an instruction group including a plurality of instructions of performing respective processings for a certain document;
a storage unit that stores:
(i) plural pieces of individual processing result information indicating results of the plurality of processings for the certain document, respectively; and
(ii) overall processing result information indicating a result of the overall instruction group.

2. The apparatus according to claim 1, further comprising:
a display device, wherein:
the control unit switches between (i) a first display mode in which the control unit controls the display device to display the plural pieces of individual processing result information thereon and (ii) a second display mode in which the control unit controls the display device to display the overall processing result information thereon.

3. The apparatus according to claim 2, further comprising:
an operation unit that allows a user to instruct the control unit to switch between the first and second display modes.

4. The apparatus according to claim 2, wherein:
in the first display mode, the control unit controls the display device to display the plural pieces of individual processing result information thereon without displaying the overall processing result information, and
in the second display mode, the control unit controls the display device to display the overall processing result information thereon without displaying the plural pieces of individual processing result information.

5. The apparatus according to claim 4, wherein:
the plural types of processings include faxing and at least one selected from the group consisting of printing, scanning, copying and sending of an electronic mail, and
the plurality of instructions include faxing the certain document to a plurality of different destinations.

6. The apparatus according to claim 4, wherein:
in the first display mode, the control unit controls the display device to display (i) the plural pieces of individual processing result information and (ii) a result of processing, which is performed by the control unit based on an instruction different from the received instruction group, thereon without displaying the overall processing result information, and
in the second display mode, the control unit controls the display device to display (i) the overall processing result information and (ii) the result of processing, which is performed by the control unit based on the instruction different from the received instruction group, thereon without displaying the plural pieces of individual processing result information.

7. The apparatus according to claim 1, wherein the plural types of processings include at least two selected from the group consisting of printing, scanning, copying, faxing and sending of an electronic mail.

8. The apparatus according to claim 1, further comprising:
a communication unit that receives the instruction group via a network from an external device.

9. The apparatus according to claim 1, further comprising:
an operation unit that allows a user to input the instruction group into the control unit.

10. The apparatus according to claim 1, further comprising:
an image processing unit that performs at least a part of the instructions of the instruction group for the certain document.

11. A document processing method comprising:
receiving an instruction group including a plurality of instructions of performing respective processings for a certain document;
performing the respective processing for the certain document based on the received instruction group;
storing:
(i) plural pieces of individual processing result information indicating results of the plurality of processings for the certain document, respectively; and
(ii) overall processing result information indicating a result of the overall instruction group.

12. The method according to claim 11, further comprising:
displaying one of (i) the plural pieces of individual processing result information and (ii) the overall processing result information; and
switching the displaying of the one of (i) the plural pieces of individual processing result information and (ii) the overall processing result information to displaying of the other.

13. A computer readable recording medium storing a program causing a computer to execute document processing, the document processing comprising:
receiving an instruction group including a plurality of instructions of performing respective processings for a certain document;
performing the respective processing for the certain document based on the received instruction group;
storing:
(i) plural pieces of individual processing result information indicating results of the plurality of processings for the certain document, respectively; and
(ii) overall processing result information indicating a result of the overall instruction group.

14. The medium according to claim 13, wherein the document processing further comprises:
displaying one of (i) the plural pieces of individual processing result information and (ii) the overall processing result information; and
switching the displaying of the one of (i) the plural pieces of individual processing result information and (ii) the overall processing result information to displaying of the other.
